(19) United States
(12) Patent Application Publication
(10) Pub. No.: US 2017/0259254 A1
(43) Pub. Date: Sep. 14, 2017

(54) PHOTOCATALYST APPARATUS AND SYSTEM

(71) Applicants: Kechuang LIN, Xiamen (CN); YI-JUI HUANG, Xiamen (CN)

(72) Inventors: Kechuang LIN, Xiamen (CN); YI-JUI HUANG, Xiamen (CN)

(21) Appl. No.: 15/607,567

(22) Filed: May 29, 2017

Related U.S. Application Data
(63) Continuation of application No. PCT/CN2015/080352, filed on May 29, 2015.

(51) Int. Cl. B01J 35/00; H01M 4/86; C02F 1/32; H01M 4/90

(52) U.S. Cl. CPC B01J 35/004; H01M 4/9075; H01M 4/9016; H01M 4/8605; C02F 1/32; B01J 32/00

(57) ABSTRACT

A photocatalyst apparatus includes a carrier and a photocatalyst carried by the carrier. The carrier is a porous material with a specific surface area higher than 10/mm, the specific surface area depending on different pore sizes, wherein the porous material includes a plurality of pores having a substantially uniform size with a variation of less than about 20%, wherein the size is larger than about 100 nm and smaller than about 5 mm. The photocatalyst apparatus can be used for lighting, anti bacteria, deodorant, air or water purification, etc.

### CROSS-REFERENCE TO RELATED APPLICATIONS

The present application is a continuation of, and claims priority to, PCT/CN2015/080352, filed on May 29, 2015, the disclosure of which is hereby incorporated by reference in its entirety.

### BACKGROUND

Nano-sized metal oxide materials, such as titanium dioxide (TiO₂), can be applied to the surface of a substrate forming a particle film and used as photocatalysts. Photocatalysts can be applied in many areas, including food, pharmaceutical, and cosmetics industries. For example, under UV rays, a TiO₂ photocatalyst can have a strong catalytic degradation effect, and can effectively degrade toxic or harmful gases in the air, kill a variety of bacteria, and break down or detoxicate toxins released by the bacteria or fungi. In addition, photocatalysts can also be used as deodorants or anti-contaminants.

Photocatalysts typically utilize oxygen and water molecules in the air to catalyze the conversion of organic compounds that the photocatalysts come into contact with into carbon dioxide and water. During this process, the photocatalysts remain unchanged while catalyzing the chemical reactions, thereby having a long effectiveness and incurring low maintenance cost. Meanwhile, titanium dioxide itself is nontoxic, and has been widely used in food, pharmaceutical, and cosmetics industries.

### SUMMARY

The present disclosure relates to photocatalyst apparatuses comprising fine-array porous materials, and to their practical applications.

Some embodiments disclosed herein provide photocatalyst apparatuses comprising high surface-area-to-volume ratio fine-array porous films with a surface area larger than 100 cm², such as 20 cm×20 cm. In some embodiments, the photocatalyst apparatuses comprise a large bulk fine-array porous material with a three-dimensional (3D) structure.

The sizes of the pores of the fine-array porous films or fine-array porous materials with 3D structure can be, for example, about 100nm -5 mm. Meanwhile, the pores in these materials have substantially uniform sizes, with a variation of <20%, or of <10% according to some embodiments. These features are in contrast with the porous materials manufactured by existing approaches. For example, existing metal foams typically have a pore size of >500 μm, and a specific surface-area of about 14˜3100/mm, with large pore size variations (such as >100%).

The fine-array porous materials according to some embodiments possess features of photonic crystals, and thus can reflect light with specific wavelengths. For example, the fine-array porous materials according to some embodiments of the photocatalyst apparatus can efficiently reflect the UV light (such as through total reflection) emitted by the optical pump, a feature that allows efficient illumination of activating light by the photocatalyst apparatus, thereby significantly elevating the photocatalytic activity of the photocatalyst apparatus and additionally reducing the damage to living organisms caused by the UV light.

### BRIEF DESCRIPTION OF THE DRAWINGS

FIG. 1 illustrates a metal foam used as carrier in some existing photocatalyst apparatus.

FIG. 2 illustrates fine-array porous films used in photocatalyst apparatuses disclosed herein.

FIG. 3 illustrates a flexible fine-array porous film having properties of photonic crystals.

FIG. 4 illustrates a photocatalyst apparatus comprising a fine-array porous film and a photocatalyst film according to some embodiments.

FIG. 5 illustrates a photocatalyst apparatus comprising a fine-array porous film and photocatalyst particles disposed in pores thereof according to some embodiments.

FIG. 6 illustrates a photocatalyst apparatus comprising a fine-array porous film and photocatalyst particles disposed in pores thereof according to some embodiments.

FIG. 7 illustrates a photocatalyst apparatus comprising fine-array porous film and LED and its various embodiments.

FIG. 8 illustrates a lighting apparatus employing a porous carrier carrying a photocatalyst.

FIG. 9 illustrates a water or air filtration system employing a porous carrier carrying a photocatalyst according to some embodiments of the disclosure.

### DETAILED DESCRIPTION

Existing photocatalysts typically take the form of nano-sized powders, which generally need a binder to tightly adhere the nanoparticles together and on the surface of a porous carrier. Use of the adhesive binder can substantially reduce the working specific surface area of a photocatalyst, thereby significantly reducing the efficiency of the catalytic conversion. Therefore, to achieve standard values required for a catalytic reaction. more of the photocatalyst material may be needed. In addition, a photocatalyst may need to be irradiated with UV light to function properly. UV light has a relatively high energy, and may result in deterioration of some materials, or cause pathological changes to cells of living organisms. Existing photocatalysts often need porous carriers, whose specific surface area can determine the amount of the photocatalyst it carries, and the ability to catalyze the reaction.

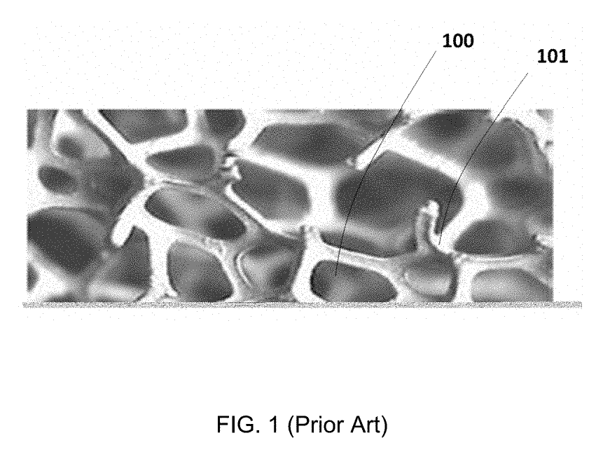

Photocatalysts can use a metal foam as a carrier. FIG. 1 illustrates the microstructure of an existing metal foam, comprising an interconnected matrix of metallic ligaments 101 with varying lengths and orientations, and individual void spaces (pores) 100 of different shapes and sizes formed between adjacent ligaments. Typical metal foams may have pore sizes of 0.5-8 mm, with a variation often higher that 100%.

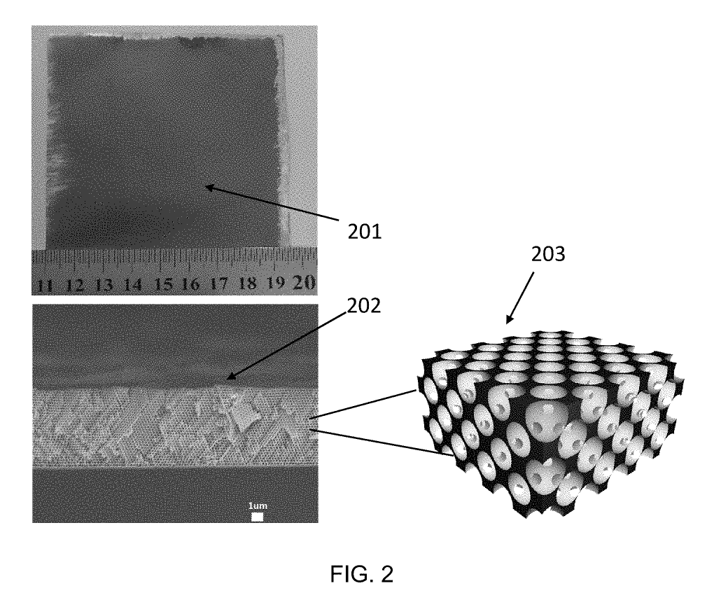

Embodiments disclosed herein provide a fine-array porous material/film that can be used as carrier for photocatalysts in a photocatalyst apparatus or system. FIG. 2 illustrates a fine-array porous film 201 used as carrier in the photocatalyst apparatuses according to some embodiments. In a sectional view 202, the microstructures 203 can be seen more clearly. The fine-array porous film has a high surface-area-to-volume ratio, with a surface area larger than 100 cm², such as 20 cm×20 cm. The fine-array porous film may have a thickness of about 5 μm-500 mm, and may have a pore size ranging from about 100 nm-5 mm. In some other embodiments, the photocatalyst apparatuses may comprise a large bulk fine-array porous material with a three-dimensional (3D) structure.

Porous materials, such as metal foams and fine-array porous materials as disclosed herein, can have high surface-area-to-volume ratios, which can be described as:

$${S}_{v} \approx \frac{281.8}{d} [ {( 1 - θ )}^{1 / 2} - ( 1 - θ ) ] \cdot {( 1 - θ )}^{0.4} ] , \qquad ( 1 )$$

where Sᵥ is the specific surface area, d is the average pore diameter in units of mm, θ is the porous ratio. For example: for a d=0.01 mm, a porous ratio of 90%, the specific surface area is 2425/mm.

Table 1 below compares parameters, as defined in association with Equation (1), of conventional metal forms with those of the fine-array porous materials disclosed herein. As shown, the specific surface areas of the fine-array porous materials can be higher than 3130/mm, such as higher than 4100/mm. However, specific surface areas of the fine-array porous materials can also be in the range of 10/mm and 3130/mm, and would still have superb properties for various applications resulting from other properties unmatched by metal forms. For example, fine-array porous materials according to some embodiments, with a specific surface area >10/mm, can have substantially uniform pore sizes, such as of <20% as measured by the standard deviation, or of <10% as measured by the standard deviation.

TABLE 1

| | d | | | (1-θ) \hat{ } | | (1-θ) \hat{ } | Sv |
|---|---|---|---|---|---|---|---|
| | (mm) | 281.8/d | θ | 0.5 | 1-Q | 0.4 | (mm2/mm3) |
| Metal | 1 | 281.8 | 0.95 | 0.224 | 0.05 | 0.302 | 14.760 |
| Foams | 0.5 | 563.6 | 0.95 | 0.224 | 0.05 | 0.302 | 29.521 |
| | 0.5 | 563.6 | 0.90 | 0.316 | 0.10 | 0.398 | 48.516 |
| | 0.5 | 563.6 | 0.85 | 0.387 | 0.15 | 0.468 | 62.618 |
| | 0.01 | 28180 | 0.95 | 0.224 | 0.05 | 0.302 | 1476.032 |
| | 0.01 | 28180 | 0.90 | 0.316 | 0.10 | 0.398 | 2425.786 |
| | 0.01 | 28180 | 0.85 | 0.387 | 0.15 | 0.468 | 3130.922 |
| Fine- | 0.01 | 28180 | 0.74 | 0.510 | 0.26 | 0.583 | 4108.658 |
| array | 0.005 | 56360 | 0.74 | 0.510 | 0.26 | 0.583 | 8217.316 |
| porous | 0.001 | 281800 | 0.74 | 0.510 | 0.26 | 0.583 | 41086.578 |

In contrast to conventional metal foams that have relatively low specific surface areas and lack of uniformity in pore sizes, the fine-array porous material has larger specific areas, and the pores therein are also highly uniform.

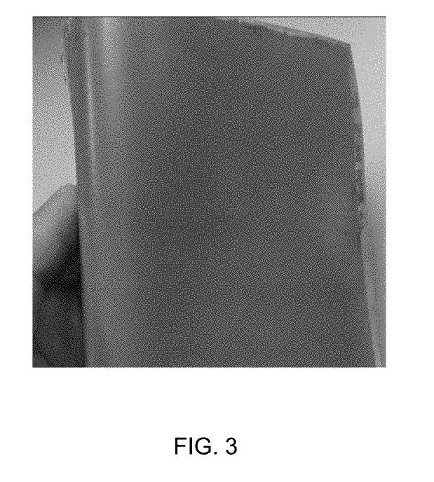

Some embodiments of the fine-array porous film, as illustrated by FIG. 3, may be flexible and may have features of photonic crystals and can reflect light of specific wavelengths, depending on the different pore sizes and the composition. The flexibility of the fine-array porous film allows it to be used as part of flexible electronics/optics apparatuses, such as wearable devices.

Disclosed herein also include photocatalyst apparatuses or systems comprising fine-array porous films/materials.

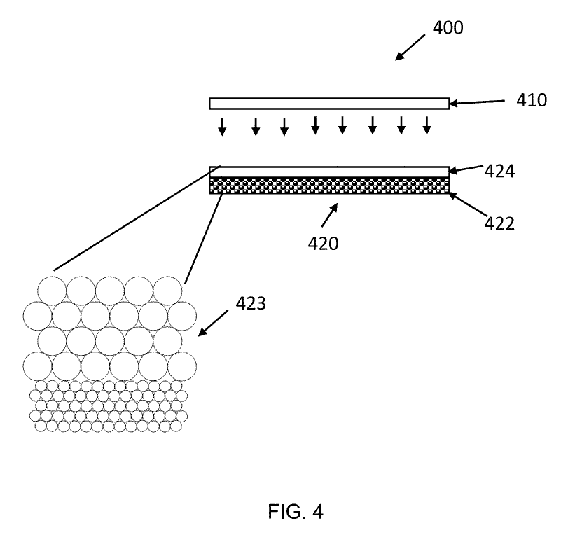

In some embodiments, as illustrated in FIG. 4, a photocatalyst apparatus 400 includes an optical pump 410 and a photocatalyst member 420, wherein the photocatalyst member 420 comprises a fine-array porous substrate film 422 and a photocatalyst film 424. The photocatalyst film 424 is disposed over the fine-array porous substrate film 422 to receive activating light from the optical pump 410. In some embodiments, a binder, such as PVA or PVB, may be used to adhere the photocatalyst film 424 with the top surface of the fine-array porous substrate film 422. In some embodiments, the optical pump 410 may be dispensable and the activating light may derive from the sun or the environment. The pore sizes of the fine-array porous substrate film 422 may be larger or smaller than the size of the particles of the photocatalyst film 424.

In the embodiment as shown in FIG. 4, the magnified view of the microstructure 423 has dual-size structure where a fine-array porous film has pore sizes substantially smaller than the sizes of the particles of the photocatalyst. The fine-array porous substrate film 422 may be made of a metal, such as Ni, Cu, etc, a ceramic, such as SiO₂, etc., or a polymer, such as polystyrene (PS) or PMMA (Poly(methyl methacrylate)). The photocatalyst film 424 may be made from Cu₂O, ZnO, TiO₂, Mn₂O₃, NiO, and NiO₂, etc.

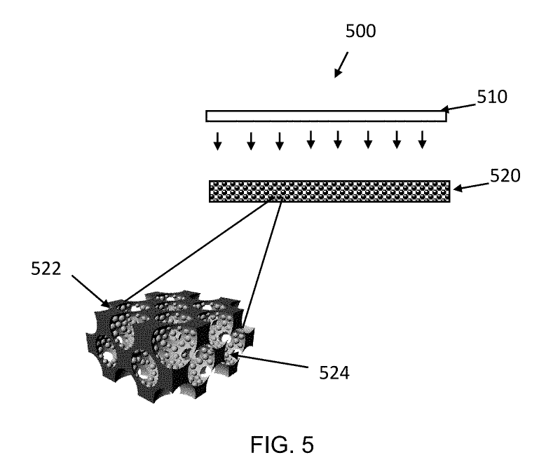

In some embodiments, as illustrated in FIG. 5, a photocatalyst apparatus 500 includes an optical pump 510 and a photocatalyst member 520, wherein the photocatalyst member 520 comprises a fine-array porous carrier 522 and a plurality of photocatalyst particles 524. The plurality of photocatalyst particles 524 have diameters smaller than the pore sizes of the fine-array porous carrier 522, and are coated on surfaces of the carrier material inside the pores of the fine-array porous carrier 522. Coating can be accomplished, for example, by dipping the sol-gel of the photocatalyst nanoparticles, followed by curing. In some embodiments, the optical pump 510 may be optional and the activating light may derive from the sun or the environment. The fine-array porous carrier 522 may be made of a metal, such as Ni, Cu, etc, a ceramic, such as SiO₂, ZnO, TiO₂, Mn₂O₃, NiO, NiO₂, etc., or a polymer, such as PS or PMMA. The photocatalyst particles 524 may be made of Cu₂O, ZnO, TiO₂, Mn₂O₃, NiO, and NiO₂, etc.

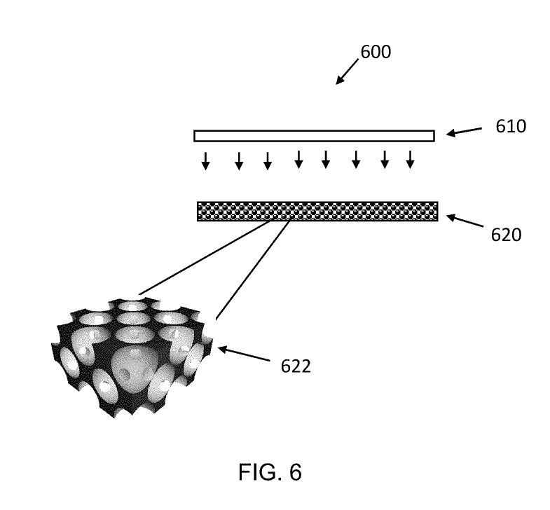

In some embodiments, as illustrated in FIG. 6, the photocatalyst apparatus 600 includes an optical pump 610 and a photocatalyst member 620, wherein the photocatalyst member 620 comprises a photocatalytic fine-array porous film 622. In some embodiments, the photocatalytic fine-array porous film 622 may be composed wholly of a photocatalytic material, such as Cu₂O, ZnO, TiO₂, Mn₂O₃, NiO, and NiO₂. In some embodiments, the photocatalytic fine-array porous film 622 may be composed a metal fine-array porous film, having its surface oxidized to form a photocatalytically active metal oxide of the same metal. Examples include Ni/NiO₂, Ti/TiO₂, Zn/ZnO, or Cu/Cu₂O etc. In some embodiments, the optical pump 610 may be optional and the activating light may derive from the sun or the environment. In some embodiments comprising metal fine-array porous film and metal oxide photocatalyst, a heating part may be also included in the photocatalyst apparatus. The heating part can be coupled to and used to heat the metal fine-array porous film to increase the temperature of the metal oxide photocatalyst to further increase its photocatalytic capability of the photocatalyst apparatus.

As a result of the very high specific surface area of the fine-array porous photocatalyst members 520 and 620 according to the embodiments as illustrated in FIGS. 5 and 6, the photocatalyst apparatuses 500 and 600 have a significantly increased probability of being illuminated by light compared with existing photocatalyst apparatuses.

In addition, by controlling the composition of the photocatalysts 424, 524 or 622, and the pore size of the fine-array porous film 422, 522 or 622 in the photocatalyst member 420, 520 or 620, in the embodiments as illustrated in FIGS. 4-6, it is possible to achieve total reflection for activating light having a given wavelength. The light reflected by the fine array porous film can significantly improve the probability for the photons (such as UV photons) to interact with the photocatalysts. Furthermore, damage to living organisms caused by the UV light can also be effectively reduced due to this feature.

For light illuminating vertically (90°) to a fine-array porous film, the light reflecting property of a film can be described by the corrected Bragg's equation:

λ_{c}=2n_{eff}×d, (2)

n_{eff}=[nₐᵢᵣ²×f+nₘₐₜₑᵣᵢₐₗ²×(1−f)]^{1/2}, (3)

wherein λ_{c} is the wavelength of light being reflected, n_{eff} is the effective refractive index, d is the distance between neighboring pores of the fine array. nₐᵢᵣ and nₘₐₜₑᵣᵢₐₗ are the refractive indices of air and a porous material, respectively; f is the volume factor of the air bubble in the fine-array porous material; d=(2/3)^{1/2}D wherein D is the diameter of the air bubble.

Table 2 below summarize the parameters of three compositions used in the fine-array porous film for the photocatalyst apparatus according to some embodiments. According to Table 2, if a fine-array porous film is made from TiO2 is used, using n_{TiO2}=2.50 and nₐᵢᵣ=1, f=0.74, and for an UV wavelength λ_{c}=365 nm, it can be calculated that D=190 nm.

TABLE 2

| λ_{c} (nm) | Material | n_{eff} | nₐᵢᵣ | nₐᵢᵣ² | nₘₐₜₑᵣᵢₐₗ | nₘₐₜₑᵣᵢₐₗ² | f | 1-f | λ_{c} | d | D (nm) |
|---|---|---|---|---|---|---|---|---|---|---|---|
| 365 | TiO2 | 1.1825 | 1 | 1 | 2.5 | 6.25 | 0.74 | 0.26 | 365 | 154.3 | 189.0 |
| | ZnO | 0.7457 | 1 | 1 | 1.7 | 2.89 | 0.74 | 0.26 | 365 | 244.7 | 299.7 |
| 450 | Cu2O | 1.3177 | 1 | 1 | 2.7 | 7.29 | 0.74 | 0.26 | 450 | 170.8 | 209.1 |
| 550 | | 1.3177 | 1 | 1 | 2.7 | 7.29 | 0.74 | 0.26 | 550 | 208.7 | 255.6 |

The bandgap (E_{g}) of TiO2/ZnO is about 3.2 eV, corresponding to a wavelength of about 1240/3.2=385 nm. Therefore, TiO2 or ZnO can absorb light with wavelengths less that 385 nm, activating the photocatalyst effects. Similarly, Cu₂O has an E_{g} of about 2.1 eV, corresponding to a wavelength of about 1240/2.1=590 nm. Therefore, Cu₂Ocan absorb almost all light with wavelengths <590 nm, activating the photocatalyst effects. Other direct-band-gap materials such as MnO, Mn₂O, RuO₂, etc. can also have the photocatalyst effects, with their different E_{g}'s determining the pore sizes of the fine-array porous materials.

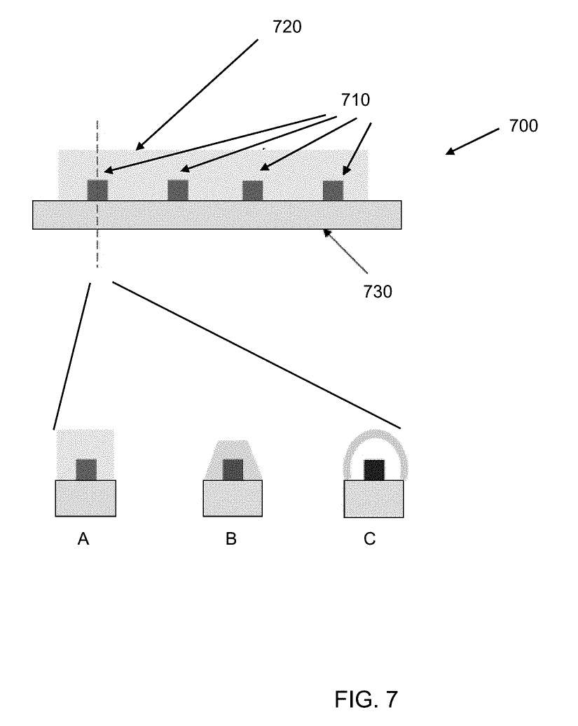

FIG. 7 illustrates a photocatalyst apparatus according to some embodiments of the present disclosure. The photocatalyst apparatus 700 includes a photocatalyst member 720 that comprises a fine-array porous film carrying photocatalyst, at least one LED 710 used as optical pump(s) to apply activating light to the photocatalyst member 720, and a substrate 730 over which the at least one LED 710 and the photocatalyst member 720 are disposed.

The photocatalyst member 720 comprises a fine-array porous film carrying photocatalysts, and can take the form of one of the embodiments 420, 520 and 620 as illustrated in FIGS. 4-6. The photocatalyst member 720 and the at least one LED 710 can be configured such that the activating light emitted by the at least one LED 710 illuminates on the photocatalyst member 720 to allow the photocatalysis reaction occurring at a surface of the photocatalyst member 720. Cross-sectional views across one of the LEDs are also shown to illustrate the various embodiments of the photocatalyst apparatus. The photocatalyst member can have the shape of, for example, a rectangle (A), a trapezoid (B), or a curve (C), etc. Although in the embodiments shown in FIG. 7 the photocatalyst member 720 has a width comparable with that of the LED 710, it is noted that other embodiments are possible. The size of the photocatalyst member 720 can be significantly larger (e.g., wider) than that of the LED. In particular, an inverse “U” shaped photocatalyst member 720 similar to that illustrated in FIG. 7 (C) can increase the surface area, as both sides of the photocatalyst member 720 come into contact with air. In addition, air heat convection/exchange can be improved.

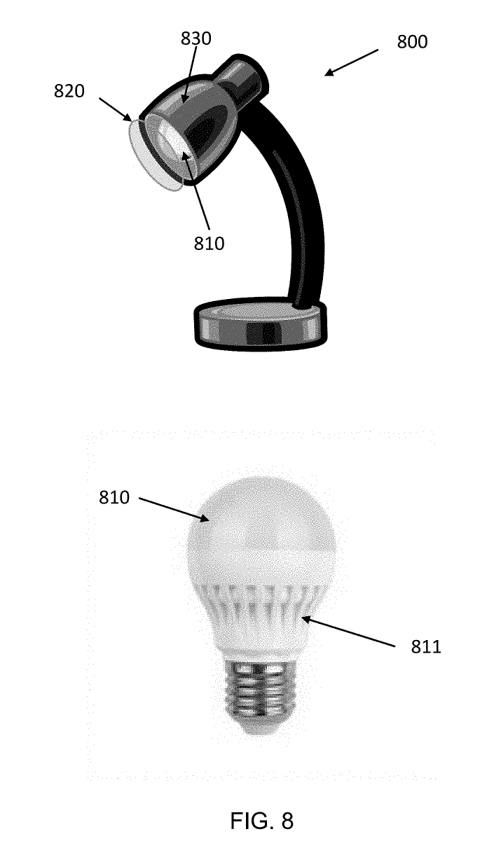

FIG. 8 illustrates a lighting apparatus comprising a fine-array porous carrier carrying photocatalysts. The lighting apparatus 800 comprises a light source 810 and a photocatalyst film 820, wherein the photocatalyst film 820 comprises a transparent fine-array porous carrier carrying photocatalysts and is disposed over the light source 810 to allow the light emitted by the light source 810 to pass through the photocatalyst film 820 and to optically pump the photocatalysts carried in the photocatalyst film 820. In some embodiments, the lighting apparatus 800 may further include a light cover 830 comprising a fine-array porous carrier carrying photocatalysts, wherein the light cover/reflector 830 is disposed around the light source 810 to allow more light emitted by the light source 810 to optically pump the photocatalysts carried by the light cover. In some embodiments, the lighting apparatus 800 may further include a housing 811 disposed on the outer surface of the light source 810. The housing 811 substantially comprises a fine-array porous carrier carrying photocatalysts, and/or has the photocatalyst particles disposed in the pores, allowing light emitted by the light source 810 to optically pump the photocatalysts in the housing 811.

The photocatalyst apparatus disclosed herein can find many applications. In one application, a photocatalyst apparatus can be installed in a refrigerator to help keep the food fresh as well as to provide lighting. This apparatus may avoid food degradation or pathological degradation of cells/nutrients under the UV light.

In another application, a photocatalyst apparatus can be used to keep flowers fresh while avoiding damaging the flowers with direct UV light.

In yet another application, a photocatalyst apparatus can be used for indoor or outdoor lighting. The photocatalyst apparatus, if used as part of an outer shell, a substrate, or a heat dissipater of a lighting device and designed to be able to utilize visible light in the photocatalysis reaction, can have advantages of facilitating air circulation and having optimal catalytic activities because of the high specific surface area of the fine-array porous film.

In yet another application, a photocatalyst apparatus can be used in a plant culturing facility, which can facilitate plant growth by providing light to plants and by effectively killing harmful bacteria and fungi.

In yet another application, a photocatalyst apparatus can be used as lighting in hospital or general indoor sanitation. The UV light pump photocatalysts can kill bacteria while human body exposure to the UV light can be reduced. For example, the UV light pump can kill germs by not only the reactive oxygen species, but also by stimulating lethal mutations in the germs. The apparatus can have air flowing there through while killing the germs in the air, with little or no UV leakage to the environment as the result of total reflection of the photonics crystal properties. In some other embodiments, non-UV light is employed as the light pump, without needing the direct germicidal properties of UV light.

In some applications, the photocatalysts used can be optically pumped by visible light. In some implementations, the photocatalysts optically pumped by visible light can be used as a part of an LED lighting apparatus for bactericidal and/or deodorant functions. For example, the fine-array porous film carrying photocatalysts can be disposed at a heat sink of the LED lighting apparatus (such as an LED lamp), and can have bactericidal/deodorant/heat-dissipating functions.

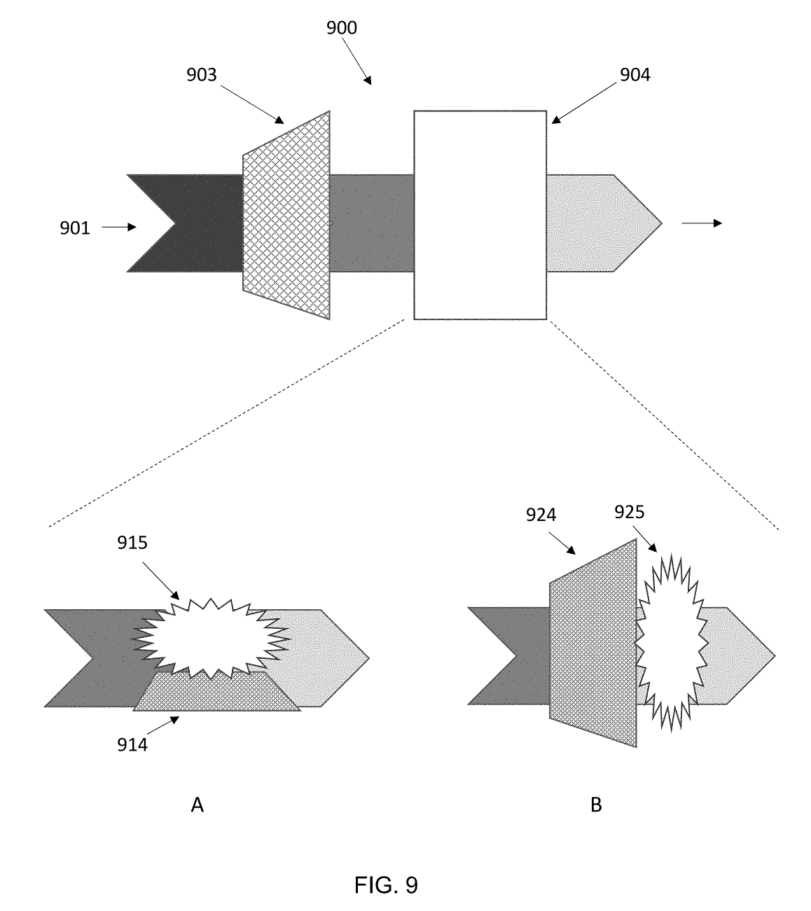

FIG. 9 illustrates a water or air filtration system 900 employing a porous carrier carrying a photocatalyst according to some embodiments of the disclosure. The filtration system 900 comprises a filter unit 903 and a photocatalytic unit 904, wherein the filter unit 903 and the photocatalytic unit 904 are configured such that a medium 901, such as air or water, can consequentially flow through the filter unit 903 and the photocatalytic unit 904, for the removal of particles contained in the medium 901 and for the photocatalytic treatment of the medium 901, respectively. In one embodiment (FIG. 9A), the photocatalytic unit 904 may comprise at least one light source 915 and at least one fine-array porous carrier 914, wherein the at least one fine-array porous carrier 914 carries photocatalysts, disposed on outer surface of, and/or in the pores of the porous carrier 914. The light emitted from the light source 915 can activate the photocatalysts in the fine-array porous carrier 914, thereby cleaning the water or air flowing through the photocatalytic unit 904. In another embodiment (FIG. 9B) of the photocatalytic unit 904, the fine-array porous carrier 924 carrying photocatalysts may itself form a filter to filter particles in the air or water flowing though the photocatalytic unit 904 in addition to its photocatalytic function stimulated by the light emitted by the light source 925.

In some embodiments, an apparatus employing a fine-array porous film carrying a photocatalyst can be used in an air filtration/purification apparatus. The photocatalytically active fine-array porous film can filter out the dust and pollutants from the air. At the same time, the photocatalysts add bactericidal/deodorant functions to the air filtration apparatus.

In some embodiments, an apparatus employing a fine-array porous film carrying a photocatalyst can be used in a water filtration/purification apparatus. Under the sunlight, the photocatalytically active fine-array porous film can filter out the dust and pollutants from the water, and have bactericidal/decontamination functions. Additionally, if combined with LED lights, such apparatus can be used in fish farms to provide lighting as well as stabilize pH and water quality; the apparatus can photocatalytically remove nitrates and amines that are generated by fish in the water.

Advantages of one or more embodiments disclosed herein may include one or more of the following. (1) The fine array porous film has a specific surface area much larger than metal forms and other carriers, and thus is a far superior carrier with significantly catalytic capability when used as a carrier for photocatalysts. (2) The fine array porous film has properties of photonic crystals, and can reflect light of specific wavelengths, thereby significantly improving the probability for photons to interact with the photocatalysts. (3) Compared with metal foams, using the fine array porous film as the carrier can reduce the UV light leakage (the portion that has not interacted with the photocatalysts), thereby reducing the chance for pathological degradations of biological cells under the UV light. (4) When implemented at the visible light wavelength range, the fine array porous film carrying the photocatalysts can be part of LED lighting devices for use as a lighting system capable of disinfection and decontamination, or act as a deodorant.

A fabrication system according to some embodiments disclosed herein can fabricate the suitable fine array porous film. The system can include a colloidal particle template formation portion configured to fabricate a colloidal particle template; an infiltration portion configured to infiltrate the colloidal particle template with an infiltrant substance; and a template removal portion configured to remove the colloidal crystal template and keep the infiltrant substance substantially intact.

A process flow of manufacturing a fine-array porous material according to some embodiments may include: (i) surface-charged particle deposition forming an array (assembly process), (ii) deposition/infiltration, and (iii) template removal. The system can include portions (e.g., modules) to respectively realize these steps. A movable conductive tape can be used to transport the colloidal particle template between the waterproof inlet and outlet of each tank.

More specifically, the following steps may be included.

(1) An electrophoresis solution containing a monodispersed colloidal nanosphere suspension can be disposed in an electrophoresis tank. A working electrode can comprise a movable continuous conductive tape configured to feed into the electrophoresis tank, provide a surface for the formation of a colloidal particle template in the electrophoresis tank, move out of the electrophoresis tank if the electrophoresis self-assembly of the colloidal particle template is complete. The working electrode can be fed at a variable rate. In some embodiments, the working electrode can be a solid, such as a metal plate, a silicon wafer, ITO glass, etc.

(2) The colloidal particle template can be transported, for example using the conductive tape or other substrate, through the oven for drying. The drying process can be performed while the template is moving (i.e., dynamic), or while the template is static inside the oven.

(3) The working electrode (e.g., tape) that comes from the electrophoresis portion carrying the dried colloidal particle template can be fed into a deposition tank for plating (such as electroplating, Sol-Gel, CVD, PVD, etc.). Using the fine array of uniformly stacked particles as a template, metal, polymers, ceramic or other materials can be plated over the template filling the space between the particles, forming a fine-array porous film over the colloidal particle template.

(4) An etching solution can be employed for removal of the colloidal particle template, and the fine-array porous film can therefore be obtained. An example of a fine-array porous film with a high specific surface area is illustrated in FIG. 5.

The fine-array porous film can be designed in the fabrication process with specific porous sizes and materials, such that it has specified optical characteristics such as reflecting/absorbing light of specific wavelengths, as described above with respect to Table 2.

One or more photocatalysts can be disposed over a sidewall or surface of the fine-array porous film.

The photocatalysts can percolate into the pores, allowing for a higher probability for them to interact with light. In some embodiments, a transparent material is used to form the fine-array porous film, such that at least some light can transmit therethrough for lighting. In some other embodiments, the fine-array porous film is designed to absorb light of specified wavelengths to increase activation of the photocatalysts. In contrast to conventional metal foams that have relatively low specific surface areas and lack of uniformity in pore sizes, the fine-array porous material has larger specific areas, and the pores therein are also highly uniform.

As a result of the designs of the pore sizes and the thickness of the fine-array porous film, the film selectively reflects and/or absorb light of specific wavelengths (such as UV), and the reflected light can further react with the photocatalysts, thereby improving the overall reaction probability between photons and the photocatalysts.

The substrate can be removed from the fine-array porous film comprising tightly stacked pores, and the resulting film can have a large area. The resulting film can also be flexible, allowing the system to take many different and/or flexible shapes.

The fine-array porous film can be cut to obtain films or specified shapes and sizes for various applications.

In some embodiments, the colloidal particle template formed by the assembly process can be made of polystyrene (PS), SiO₂, PMMA (Poly(methyl methacrylate)), or any powder substance with a sphere shape, with a particle size in the range of about 100 nm-5 mm and diameter variation (e.g., standard deviation) within about ±20%, optimally within about ±10%. For example, in an embodiment, the particle size is about 200 nm±40 nm; in another example, the particle size is about 300 nm±60 nm. The particles can have spherical shapes, and can be hollow or solid spheres. In some other embodiments, non-spherical shapes can be employed.

During the fabrication process, according to some embodiments, procedures are taken to avoid the photocatalyst particles being covered by a binding material. In some embodiments, the LED chip can be packaged first with a transparent silicone for protection, and the photocatalyst particles can then be disposed over the packaging, and can receive the pumping light while being in contact with air.

The LED substrates can be flexible, porous, or solid. The fine-array porous film can be soaked with the catalysts and then dried, and subsequently bonded to the substrate.

In addition to the photocatalyst apparatuses and systems as disclosed herein, a fine-array porous material may be employed as carriers for other chemical catalysts in other practical applications, because its significantly large specific surface area make it ideal for use as a catalyst carrier for optimized catalysis. In one embodiment, an automotive three-way catalytic converter may comprise a fine-array porous material carrying three-way catalysts, comprising at least one of platinum, palladium and rhodium, having an improved performance in simultaneous reduction of nitrogen oxides and oxidation of carbon monoxide and unburnt hydrocarbons, and thereby achieving a better vehicle emission control. In another embodiment, a fuel cell may comprise a fine-array porous material carrying appropriate catalysts, such as platinum and nickel, at its anodes and/or cathodes to allow optimized chemical reactions occurring therein. In yet another embodiment, a fine-array porous material carrying some acid catalysts, such as aluminum oxide and aluminosilicate, may be used in petrochemical industry, for instance in fluid catalytic cracking and hydrocracking.

Although specific embodiments have been described above in detail, the description is merely for purposes of illustration. It should be appreciated, therefore, that many aspects described above are not intended as required or essential elements unless explicitly stated otherwise. Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

1. A catalyst apparatus, comprising:
a porous carrier with a specific surface area higher than 10/mm, the specific surface area depending on different pore sizes, wherein the porous carrier comprises a plurality of pores having a substantially uniform size with a variation of less than about 20%, wherein the size is larger than about 100 nm and smaller than about 5 mm; and
at least one catalyst disposed over the porous carrier.

2. The catalyst apparatus of claim 1, further comprising an optical pump configured to emit light for interaction with the catalyst, wherein the catalyst comprises a photocatalyst.

3. The catalyst apparatus of claim 2, wherein the optical pump comprises at least one light-emitting diode (LED).

4. The catalyst apparatus of claim 3, wherein the at least one LED is configured to emit light in visible spectrum, and the photocatalyst is configured to be optically pumpable by the light emitted by the at least one LED.

5. The catalyst apparatus of claim 4, wherein the photocatalyst is composed of at least one of Cu₂O, ZnO, TiO₂, Mn₂O₃, NiO, or NiO₂.

6. The catalyst apparatus of claim 2, wherein the optical pump is configured to emit UV light.

7. The catalyst apparatus of claim 1, wherein the carrier comprises a fine-array porous film having a selected thickness and pore sizes such that the fine-array porous film is configured to reflect light of specified wavelengths to improve interactions between the light and the catalyst, wherein the catalyst comprises a photocatalyst.

8. The catalyst apparatus of claim 1, wherein the at least one catalyst form a film disposed over a surface of the porous carrier.

9. The catalyst apparatus of claim 1, wherein the at least one catalyst form particles disposed in pores of the porous carrier.

10. The catalyst apparatus of claim 1, wherein the porous carrier is composed of a metal selected from Ni, Ti, Zn, or Cu₂O, and the at least one catalyst comprises a photocatalytically active metal oxide formed by oxidation of the metal on a surface the porous carrier.

11. The catalyst apparatus of claim 10, further comprising a heating part, wherein the heating part is coupled with the porous carrier to heat the at least one catalyst to increase photocatalytic capability of the catalyst apparatus.

12. The catalyst apparatus of claim 10, wherein the metal is Ti and the photocatalytically active metal oxide is TiO₂.

13. The catalyst apparatus of claim 10, wherein the metal is Cu and the photocatalytically active metal oxide is Cu₂O.

14. The catalyst apparatus of claim 1, wherein the at least one catalyst comprises at least one of platinum, palladium, rhodium, nickel, aluminum oxide, or aluminosilicate.

15. The catalyst apparatus of claim 14, wherein the catalyst apparatus is configured as a three-way catalytic converter.

16. The catalyst apparatus of claim 1, wherein the one catalyst comprises at least one of aluminum oxide or aluminosilicate, and wherein the catalyst apparatus is configured as a chemical cracking apparatus.

17. The catalyst apparatus of claim 1, wherein the one catalyst comprises at least one of platinum or nickel, and wherein the catalyst apparatus is configured as a fuel cell apparatus.

18. A lighting system comprising:
a light source; and
a photocatalyst film, comprising:
a fine-array porous film with a specific surface area higher than 10/mm, the specific surface area depending on different pore sizes, wherein the porous material comprises a plurality of pores having a substantially uniform size with a variation of less than about 20%, wherein the size is larger than about 100 nm and smaller than about 5 mm, and wherein the fine-array porous film is configured to filter air or water; and
at least one photocatalyst disposed over the porous carrier;
wherein the photocatalyst film is disposed over the light source to allow the light emitted by the light source to pass through the photocatalyst film and to optically pump the photocatalysts carried in the photocatalyst film.

19. The lighting system according to claim 18, further comprising a photocatalytically active light cover disposed around the light source, wherein the photocatalytically active light cover comprises:
a fine-array porous film with a specific surface area higher than 10/mm, the specific surface area depending on different pore sizes, wherein the porous material comprises a plurality of pores having a substantially uniform size with a variation of less than about 20%, wherein the size is larger than about 100 nm and smaller than about 5 mm, and wherein the fine-array porous film is configured to filter air or water; and
at least one photocatalyst disposed over the porous carrier.

20. A filtration system comprising:
a fine-array porous film with a specific surface area higher than 10/mm, the specific surface area depending on different pore sizes, wherein the porous material comprises a plurality of pores having a substantially uniform size with a variation of less than about 20%, wherein the size is larger than about 100 nm and smaller than about 5 mm, and wherein the fine-array porous film is configured to filter air or water;
at least one photocatalyst disposed over the porous carrier; and
an optical pump configured to emit light over the photocatalyst for bactericidal and/or deodorant functions;
wherein the emitted light is UV light;
wherein the optical pump comprises LEDs; and
wherein the fine-array porous film has a selected thickness and pore sizes such that the film is configured to reflect light of specified wavelengths to improve interactions between the light and the photocatalyst.
